(19) United States
(12) Patent Application Publication
(10) Pub. No.: US 2009/0015840 A1
(43) Pub. Date: Jan. 15, 2009

(54) MINIATURE SURFACE PLASMON RESONANCE SENSOR CHIP

(75) Inventors: Chii-Wann Lin, Taipei (TW); Chih-Kung Lee, Taipei (TW); Tz-Bin Wang, Taipei (TW); Chi-Shen Tuan, Hsinchu (TW); Yueh-Yuan Fang, Taipei (TW)

Correspondence Address: HOFFMANN & BARON, LLP, 6900 JERICHO TURNPIKE, SYOSSET, NY, 11791, US

(73) Assignee: NATIONAL TAIWAN UNIVERSITY, Taipei (TW)

(21) Appl. No.: 11/849,573

(22) Filed: Sep. 4, 2007

(30) Foreign Application Priority Data
Jul. 13, 2007 (TW) 096125733

(51) Int. Cl. G01N 21/55

(52) U.S. Cl. 356/445

(57) ABSTRACT

The present invention provides a miniature surface plasmon resonance sensor chip that produces a plane light source with an organic optoelectronic material by an electro-luminescence method and excites a surface plasmon resonance wave to observe a signal variation at the surface of a sensor chip caused by the combining condition of surface bio-molecules and provide a more accurate miniature sensor in conformity with micro-channel.

### FIELD OF THE INVENTION

The present invention relates to a miniature surface plasmon resonance sensor chip, and more particularly to a miniature surface bio-molecule sensor chip made of an organic optoelectronic material and capable of producing a plane light source by an electro-luminescence method and exciting a surface plasmon resonance wave to observe a surface of the sensor chip.

### BACKGROUND OF THE INVENTION

At present, large-scale researches on the levels of a protein such as a receptor and a hormone are conducted, in hope of achieving a better understanding of the important functions such as the mechanism of diseases, the operation of cells and the cell network information. These works are important to the development of new medicines, particularly helpful to the development of medicines that have effects on the proteins in a cell. However, the bottleneck of the works of this type resides on the requirements for huge manpower consumption, enhanced sensitivity and miniaturization in order to meet the requirements for on-site measurements.

As to the bio-chip detection technology, the detection generally adopts an optical method for the requirement of a high sensitivity. Although the light emitting method is used extensively, yet the surface plasmon resonance (SPR) is also an important detection method because it requires no label and provides instant measurements.

Referring to FIG. 1 for a conventional surface plasmon resonance system that is produced by exciting a metal surface with laser, the principle of the system primarily detects a variation of the incident laser beam that excites a metal surface, and thus the system needs an optical path calibration which will make the operation becomes more complicated, time-consuming and laborious.

On the other hand, OLED is applied in sensors, and most applications use OLED as a light source as well as a basis for luminescence detections. Such detection method requires a process of dyeing a biological specimen before issuing a signal by exciting a detecting region, and an instant chemical examination and measurement of the biological specimen cannot be performed directly, and the major drawback resides on that the dyeing process may destroy the activity of the biological specimen.

It is an important subject for researchers and manufacturers to develop a miniature surface plasmon resonance sensor chip that produces a plane light source with an organic optoelectronic material by an electro-luminescence method and excites a surface plasmon resonance wave to observe a signal variation at the surface of a sensor chip that is caused by the combining condition of surface bio-molecules and provide a more accurate miniature sensor in conformity with the micro-channel.

### SUMMARY OF THE INVENTION

In view of the shortcomings of the prior art, the inventor of the present invention based on years of experience in the related industry to conduct extensive researches and experiments, and finally developed a miniature surface plasmon resonance sensor chip that produces a plane light source with an organic optoelectronic material by an electro-luminescence and excites a surface plasmon resonance wave to achieve the effect of observing surface bio-molecules at the surface of a sensor chip.

To achieve the foregoing objective, the present invention provides a miniature surface plasmon resonance sensor chip, comprising: a micro-channel module layer, having at least one micro-ditch thereon; a window layer, covered onto a surface of the micro-channel module layer with the micro-ditch, for forming at least one micro-channel; a metal ring, installed at the micro-channel and a surface of the metal ring is attached on a surface of the window layer, and another surface of the metal ring is coated with a bio-molecule passing through the micro-channel; at least one anode terminal, electrically coupled to a light emitting portion, and the anode terminal and the light emitting portion are disposed on another surface of the window layer, and the metal ring is situated in a region corresponding to the light emitting portion; an optical sensor, installed on another surface of the window layer, and in a region corresponding to the metal ring; a hole transport layer, covered onto the window layer, such that the anode terminal and the light emitting portion are disposed between the hole transport layer and the window layer; and an emitting material layer, disposed between a metal layer and the hole transport layer, and the metal layer serves as a cathode terminal of the miniature surface plasmon resonance sensor chip.

Therefore, a plane light source can be produced with an organic optoelectronic material by an electro-luminescence method and a surface plasmon resonance wave is excited to achieve the purpose of observing surface bio-molecules at the surface of a sensor chip.

The above and other objects, features and advantages of the present invention will become apparent from the following detailed description taken with the accompanying drawing.

### BRIEF DESCRIPTION OF THE DRAWINGS

FIG. 1 shows a conventional surface plasmon resonance system produced by exciting a metal surface with laser;

FIG. 2 is a side section view of a first preferred embodiment of the present invention;

FIG. 3 is a three-dimensional view of a first preferred embodiment of the present invention;

FIG. 4 is a perspective view of a first preferred embodiment of the present invention;

FIG. 5 is a perspective view of a second preferred embodiment of the present invention;

FIG. 6 is a perspective view of a third preferred embodiment of the present invention;

FIG. 7 is a perspective view of a fourth preferred embodiment of the present invention;

FIG. 8 is a schematic view of a surface plasmon distribution of a metal and a dielectric;

FIG. 9 is a schematic view of propagating surface plasmons the Z-axis direction;

FIG. 10 is a graph of the dispersion relation at surface plasmon/photon interface;

FIG. 11 is a schematic view of expanding SPR signal at a chip surface by various incident lights of different angles;

FIG. 12 is a schematic view of a SPR signal of a single-point luminescence and successive multiple-point measurement; and

FIG. 13 is a schematic view of a SPR signal of a multiple-point luminescence and single-point measurement.

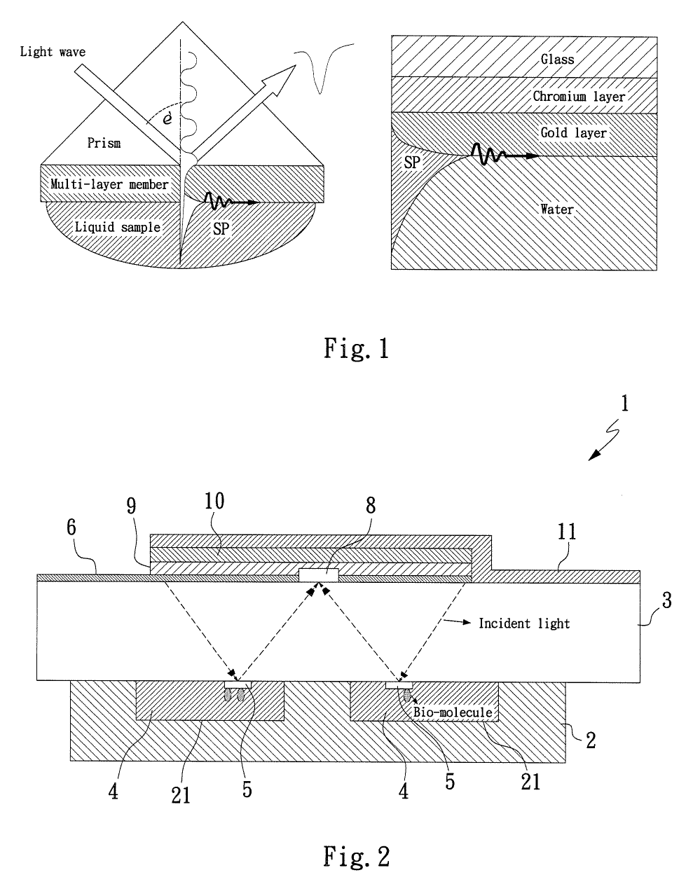

### DETAILED DESCRIPTION OF THE PREFERRED EMBODIMENTS

To make it easier for our examiner to understand the objective, innovative features and performance of the present invention, we use preferred embodiments and the accompanying drawings for a detailed description of the present invention.

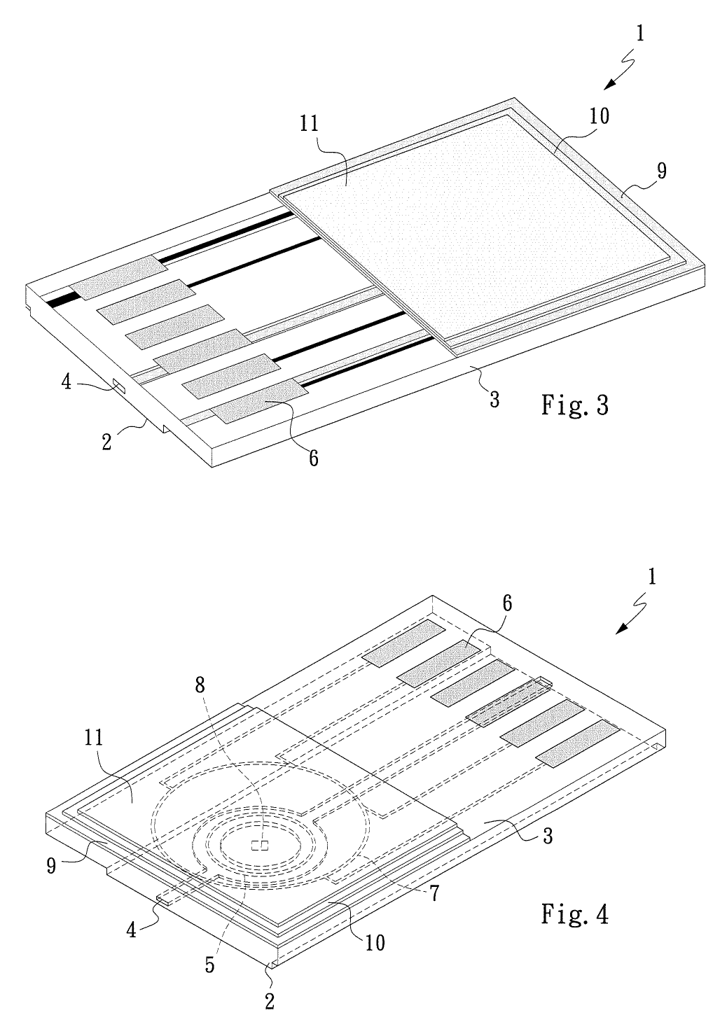

Referring to FIGS. 2 to 4 for a side section view, a three-dimensional view and a perspective view of a first preferred embodiment of the present invention respectively, the invention provides a miniature surface plasmon resonance sensor chip 1, comprising: a micro-channel module layer 2, having at least one micro-ditch 21 therein; a window layer 3 (made of a glass or light transmitting material), covered onto the micro-channel module layer 2 on a surface with the micro-ditch 21 to form at least one micro-channel 4; a metal ring 5 (including but not limited to a gold ring), installed at the micro-channel 4, and a surface of the metal ring 5 is attached onto a surface of the window layer 3, and another surface of the metal ring 5 is coated with bio-molecules passing through the micro-channel 4, and the micro-channel 4 is in a ring shape at the position of the metal ring 5, wherein the bio-molecule is one selected from the collection of DNA, RNA, protein, lipid, carbohydrate or hormone; at least one anode terminal 6, made of indium tin oxide, and electrically coupled to a circular light emitting portion 7, and the anode terminal 6 and the light emitting portion 7 are disposed on another surface of the window layer 3, and the metal ring 5 is situated in a region corresponding to the light emitting portion; an optical sensor 8, installed on another surface of the window layer 3 and corresponding to the center of the metal ring 5; a hole transport layer 9, covered onto the window layer 3, such that the anode terminal 6 and the light emitting portion 7 are disposed between the hole transport layer 9 and the window layer 3; an emitting material layer 10, disposed between a metal layer 11 and the hole transport layer 9, and the emitting material layer 10 is composed of at least one organic emitting material layer or at least one polymer emitting material layer, and the metal layer 11 serves as a cathode terminal of the miniature surface plasmon resonance sensor chip 1.

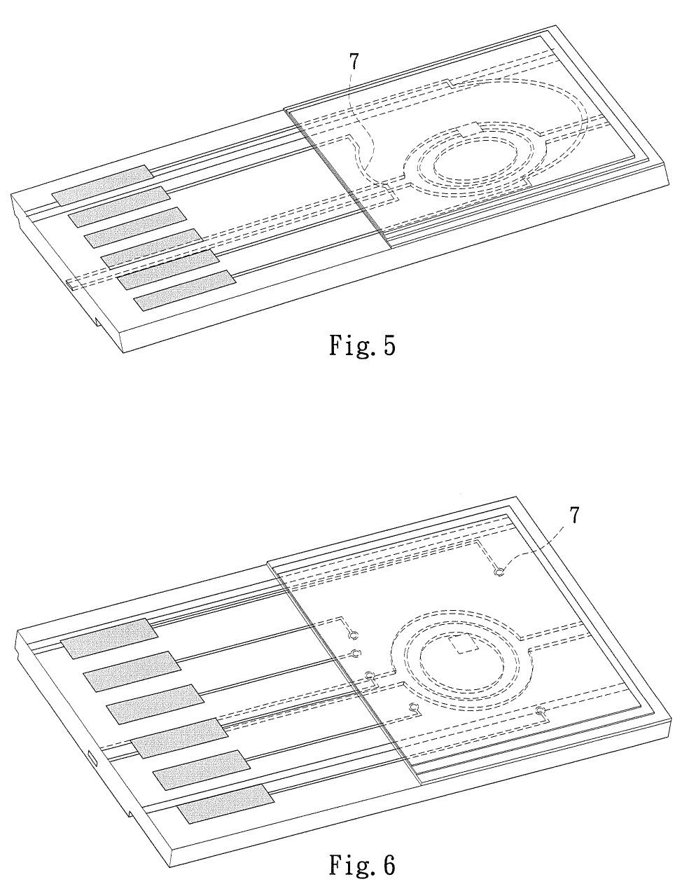

Referring to FIGS. 5 and 6 for perspective views of a second preferred embodiment and a third preferred embodiment of the present invention respectively, the difference of these preferred embodiments from the first preferred embodiment resides on that the light emitting portion 7 is in an arc shape and it provides a point light source.

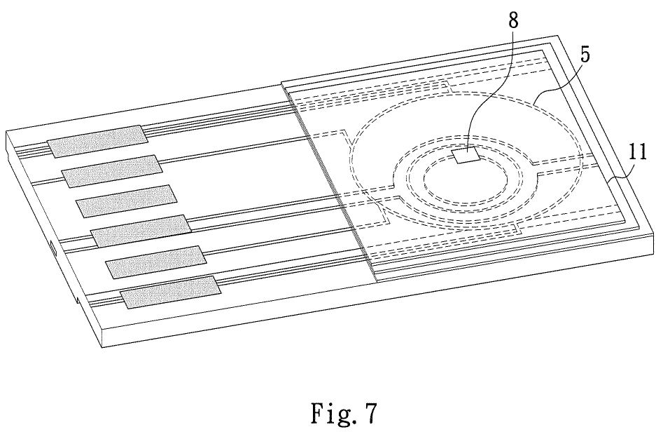

Referring to FIG. 7 for a perspective view of a fourth preferred embodiment of the present invention, the difference of this preferred embodiments from the first preferred embodiment resides on that the optical sensor 8 is installed on the metal layer 11 and corresponding to the center of the metal ring 5.

The position for installing the optical sensor 8 as adopted in the fourth preferred embodiment can be used for the second and third preferred embodiments as well, and the detail will not be described here.

The related principle and formulas of the surface plasmon wave and the variation detection analysis method of the present invention are described as follows:

Surface Plasmon Wave

The behaviors of free electrons and positive charges in a metal can be described by plasma, and its plasma frequency ωₚ is shown in (eq.1), where N is the charge density, qₑ is the number of charges, mₑ the electron mass, ε₀ is the dielectric constant of free space, and

$$\begin{matrix}{ω}_{p} = \sqrt{\frac{4 π {Nq}_{e}^{2}}{{ɛ}_{0} {m}_{e}}} & ( eq . 1 ) \\ {ɛ}_{p} ( ω ) = 1 - {( \frac{{ω}_{p}}{ω} )}^{2} & ( eq . 2 )\end{matrix}$$

The dielectric constant εₚ of plane electromagnetic waves in a medium is related to frequency ω as shown in (eq.2). If the frequency is ωₚ, then εₚ is negative, and the refractive index \sqrt{εₚ} is a complex number. By then, the evanescent wave is non-radiactive. In other words, if a metal medium absorbs electromagnetic waves and causes a surface charge oscillation, the maximum intensity of electric field at the metal-dielectric interface is attenuated towards both sides of the electric field, and its skin depth y is shown in (eq.3), where α is the attenuation coefficient and k is the extinction coefficient.

$$y = \frac{1}{α} = \frac{c}{2 ω k} \qquad ( eq . 3 )$$

If the frequency of electromagnetic waves is greater than ωₚ, then radiative transfer can be conducted in a metal.

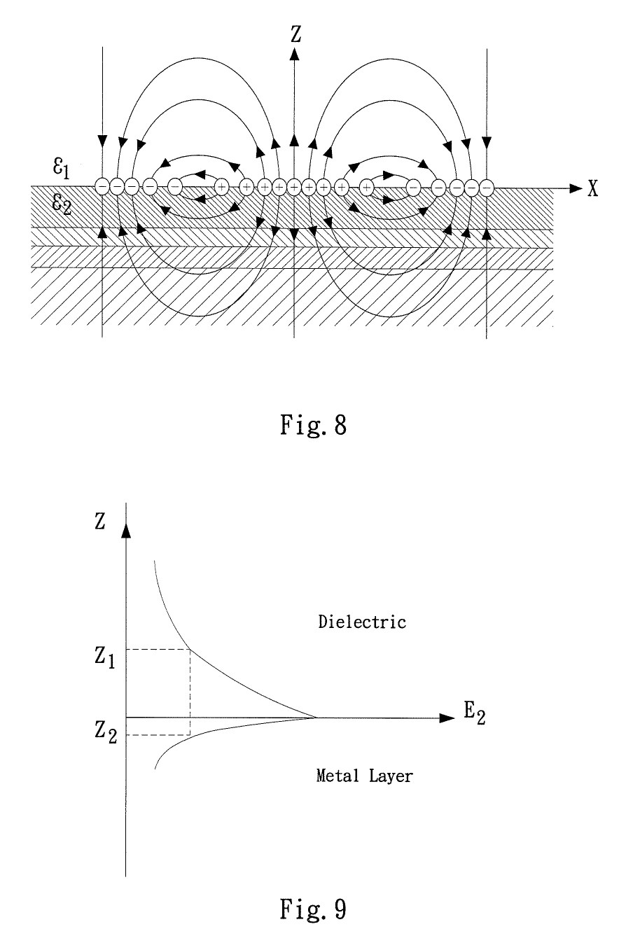

Surface plasmon is an electromagnetic mode that restricts the transfer of electromagnetic wave at the interface of a metal ε₂ and a dielectric ε₁ by the surface charge density as shown in FIG. 8. Since the surface potential V_{kω} is formed by surface charges σ_{kω}, as shown in (eq.4), the surface plasmon must exist at the interface ε₁·ε₂<0 of (eq.6) under the limitation of the boundary condition (eq.5), which is the metal-dielectric interface. The electric field of the surface plasmon wave (SPW) is perpendicular to the electromagnetic wave at the interface (and thus it is necessary to use TM waves to satisfy the boundary condition to excite SPW), and the fluctuation of a charge density variation at the surface will result. Since there is a discrete phenomenon at the interface of the electric field perpendicular to the surface, and the dielectric coefficient of the dielectric is greater than zero, and the dielectric coefficient of the metal is smaller than zero, therefore the direction of electric field is reversed, and surface charges are produced.

$$\begin{matrix}{V}_{k ω} ( r , t ) = \frac{2 {πω}_{k ω}}{k} \cdot {e}^{- k \vert Z \vert} \cdot {e}^{j ( kx - ω t )} & ( eq . 4 ) \\ {ɛ}_{1} ( ω ) {E}_{z} ( z = {0}^{+} , ω ) = {ɛ}_{2} ( ω ) {E}_{z} ( z = {0}^{\cdot } , ω ) & ( eq . 5 ) \\ ∵ {E}_{z} ( z = {0}^{+} , ω ) = - {E}_{z} ( z = {0}^{\cdot } , ω ) ∴ {ɛ}_{1} ( ω ) = - {ɛ}_{2} ( ω ) & ( eq . 6 )\end{matrix}$$

The skin depth of the surface plasmon propagated in the Z-axis direction is represented by (eq.7) and (eq.8), and z1 is usually greater than z2. In other words, the surface plasmon in the dielectric can be propagated to a farther distance as shown in FIG. 9.

$$\begin{matrix}{z}_{1} = {\frac{c}{2 ω} [ \frac{{ɛ}_{1} + {ɛ}_{2}^{′}}{{ɛ}_{1}^{2}} ]}^{1 / 2} & ( eq . 7 ) \\ {z}_{2} = {\frac{c}{2 ω} [ \frac{{ɛ}_{1} + {ɛ}_{2}^{′}}{{ɛ}_{2}^{′2}} ]}^{1 / 2} & ( eq . 8 )\end{matrix}$$

The dispersion relation can be derived from the Maxwell's equation and the boundary condition as shown in (eq.9), where, kₓ is the x^{th} component of the wave vector.

$${k}_{x} = \frac{ω}{c} \sqrt{\frac{{ɛ}_{1} {ɛ}_{2}}{{ɛ}_{1} + {ɛ}_{2}}} = {k}_{x}^{′} + j {k}_{x}^{″} \qquad ( eq . 9 )$$

In general, a metal has the light absorption property, and thus ε₂=ε₂′+ε₂″ is substituted into (eq.9) to obtain (eq.10) and (eq.11):

$$\begin{matrix}{k}_{x}^{′} = {\frac{ω}{c} [ \frac{{ɛ}_{1} {ɛ}_{2}^{′}}{{ɛ}_{1} + {ɛ}_{2}^{′}} ]}^{1 / 2} & ( eq . 10 ) \\ {k}_{x}^{′} = {\frac{ω}{c} [ \frac{{ɛ}_{1} {ɛ}_{2}^{′}}{{ɛ}_{1} + {ɛ}_{2}^{′}} ]}^{3 / 2} \cdot \frac{{ɛ}_{2}^{″}}{2 {( {ɛ}_{2}^{′} )}^{2}} & ( eq . 11 )\end{matrix}$$

For metals, ε₂^{′}<0, if |ε₂^{′}|>ε₁, then kₓ^{′} is a real number, and

$${k}_{x}^{′} > \frac{ω}{c}$$

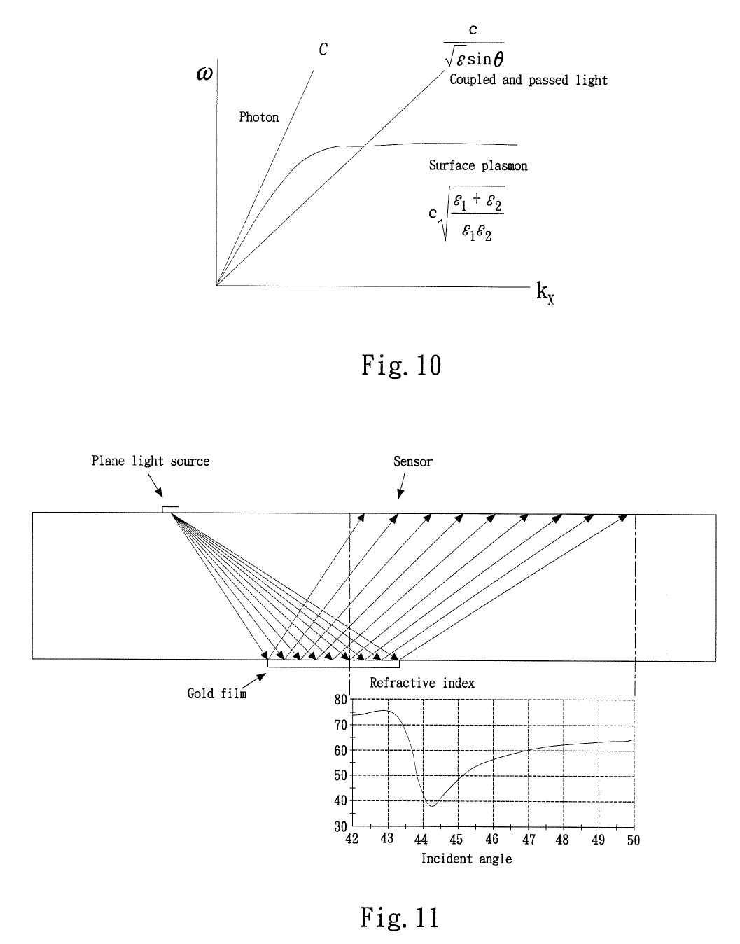

shows a dispersion relation. Referring to FIG. 10 for the dispersion relation at an interface of the surface plasmon and the photon, the dispersion relation of the light in the air (indicated by the straight line on the left) falls on the left side of the dispersion relation of the surface plasmon (indicated by the curve on the right), and the two lines are not intersected, indicating that the frequency of the surface plasmon is very high, and the light propagated in the air cannot provide sufficient momentum (or kₓ) to excite the surface plasmon. In other words, the momentum (X-axis) and the energy (Y-axis) of the two are not conserved.

Exciting Surface Plasmon Resonance

To perform an optical measurement of a surface variation by the characteristic of surface plasmon resonance (SPR), it is necessary to transfer the wave propagation energy of the light of the bulk material to the surface plasmon wave, such that the wave propagations of both interfaces have the same momentum and kinetic energy. In (eq.12), Px stands for the momentum, and h stands for the Plank constant, and thus it is necessary to satisfy the wave vector matching condition (eq.13) in order to excite the surface plasmon resonance. In other words, the wave vector (eq.14) at the photon interface is equal to the wave vector (eq.15) at the surface plasmon interface.

$$\begin{matrix}{P}_{x} = \dot{h} {k}_{x} , \dot{h} = \frac{h}{2 π} & ( eq . 12 ) \\ {k}_{x , light} = {k}_{x , spr} & ( eq . 13 ) \\ {k}_{x , light} = {k}_{0} \sqrt{{ɛ}_{d}} sin θ & ( eq . 14 ) \\ {k}_{x , spr} = Re [ {k}_{0} \sqrt{\frac{{ɛ}_{d} {ɛ}_{m}}{{ɛ}_{d} + {ɛ}_{m}}} & ( eq . 15 )\end{matrix}$$

where, θ is the incident angle of light, and εd and εm are the dielectric constants of the dielectric and metal respectively, and k0 is the wave vector in free space.

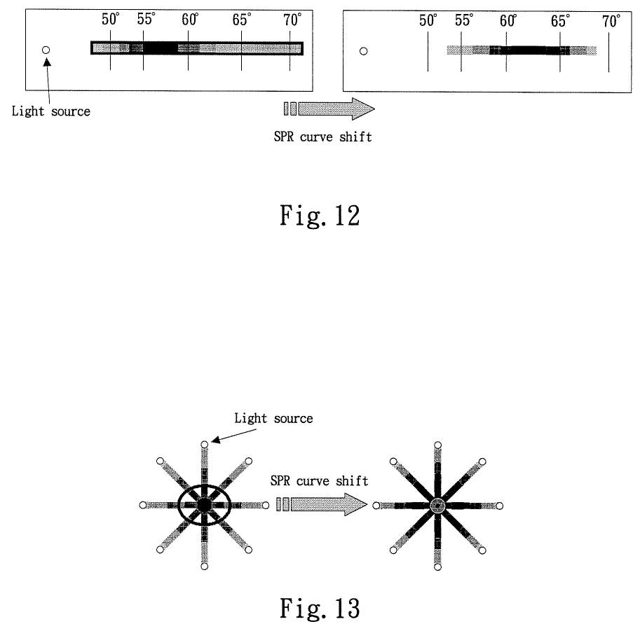

The present invention mainly bases on the physical phenomenon of surface plasmon waves and uses an organic light-emitting diode (OLED) or a polymer light-emitting diode (PLED) to create a plane light source at a chip surface and produce a gold film on another surface of the chip for combining bio-molecules. The excited light of the plane light source is projected onto the surface of the gold film at different incident angles and returned together with the reflected light of different intensities. The SPR signal on the gold film is expanded onto the surface of the chip as shown in FIG. 11. The positions of the gold film and the optical sensor are adjusted to perform a single-point or a multiple-point measurement for measuring the optical characteristic variation at the gold film interface to conduct a chemical examination of the biological specimen directly. The shape of the light source can be a single-point light emission or a continuous multiple-point measurement for monitoring the intensity of each reflective angle as shown in FIG. 12, or a multiple-point, arc or circular light source emission used for geometric focusing and a single-point measurement can increase the signal variability and eliminate irrelevant signals as shown in FIG. 13. According to this design, the substrate of a chip (or a dielectric layer) can be used as a wave vector coupling of the gold film in order to save the use of prisms. OLED and PLED are materials that emit a light source with a specific range of wavelengths, and can replace laser or a light source system having incandescent light bulbs and filters adopted in traditional SPR detections. Further, the PLED can produce aligned liquid crystal polymers by the method of introducing mesogens into side-chain polymers, and radiate polarized light, so as to save the polarizer used in traditional SPR detections.

The present invention can use the characteristics of different light sources and different geometric shapes of the gold film to achieve the effect of filtering irrelevant signals and greatly save the components required in traditional SPR detections. A high-precision micro-electro-mechanical surface micromatching process is used to complete the optical path alignment, such that a wire width of tens of microns can be produced in a light emitting region, if the thickness of the chip substrate is approximately equal to 1.1 mm, and the precision of the optical path alignment is up to 0.05 degrees, and the signal overlapping error caused by the dimensions of the components can be reduced to 0.25 degrees. A micro-channel system is built in the flow to provide the injection of a test sample, and the geometric characteristics are used for an automatic optical path alignment.

In view of the description above, the present invention provides a miniature surface plasmon resonance sensor chip that produces a plane light source with an organic optoelectronic material by an electro-luminescence method and excites a surface plasmon resonance wave to observe a signal variation at the surface of a sensor chip. Therefore, the present invention complies with the patent application requirements, and is duly filed for patent application.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A miniature surface plasmon resonance sensor chip, comprising:
a micro-channel module layer, having at least one micro-ditch thereon;
a window layer, covered onto a surface of the micro-channel module layer with the micro-ditch, for forming at least one micro-channel;
a metal ring, installed at the micro-channel, and a surface of the metal ring is attached on a surface of the window layer, and another surface of the metal ring is coated with a bio-molecule passing through the micro-channel;
at least one anode terminal, electrically coupled to a light emitting portion, and the anode terminal and the light emitting portion are disposed on another surface of the window layer, and the metal ring is situated in a region corresponding to the light emitting portion;
an optical sensor, installed on another surface of the window layer, and in a region corresponding to the metal ring;
a hole transport layer, covered onto the window layer, such that the anode terminal and the light emitting portion are disposed between the hole transport layer and the window layer; and
an emitting material layer, disposed between a metal layer and the hole transport layer, and the metal layer serves as a cathode terminal of the miniature surface plasmon resonance sensor chip.

2. The miniature surface plasmon resonance sensor chip of claim 1, wherein the optical sensor is installed on another surface of the window layer and corresponding to the center of the metal ring.

3. The miniature surface plasmon resonance sensor chip of claim 1, wherein the optical sensor is installed on the metal layer, and corresponding to the center of the metal ring.

4. The miniature surface plasmon resonance sensor chip of claim 1, wherein the window layer is made of glass.

5. The miniature surface plasmon resonance sensor chip of claim 1, wherein the window layer is made of a transparent dielectric.

6. The miniature surface plasmon resonance sensor chip of claim 1, wherein the metal ring is a gold ring.

7. The miniature surface plasmon resonance sensor chip of claim 1, wherein the anode terminal is made of indium tin oxide (ITO).

8. The miniature surface plasmon resonance sensor chip of claim 1, wherein the light emitting portion is in a ring shape.

9. The miniature surface plasmon resonance sensor chip of claim 1, wherein the light emitting portion is in an arc shape.

10. The miniature surface plasmon resonance sensor chip of claim 1, wherein the light emitting portion is a point light source.

11. The miniature surface plasmon resonance sensor chip of claim 1, wherein the emitting material layer is composed of at least one organic emitting material layer.

12. The miniature surface plasmon resonance sensor chip of claim 1, wherein the emitting material layer is composed of at least one polymer emitting material layer.

13. The miniature surface plasmon resonance sensor chip of claim 1, wherein the bio-molecule is one selected from the collection of DNA, RNA, protein, lipid, carbohydrate or hormone.
